(19) United States
(12) Patent Application Publication
(10) Pub. No.: US 2014/0376699 A1
(43) Pub. Date: Dec. 25, 2014

(54) X RAY WAVEGUIDE SYSTEM

(71) Applicants: Atsushi Komoto, Moriya-shi (JP); Hirokatsu Miyata, Hadano-shi (JP); Kohei Okamoto, Yokohama-shi (JP); Wataru Kubo, Inagi-shi (JP); Takashi Noma, Hadano-shi (JP)

(72) Inventors: Atsushi Komoto, Moriya-shi (JP); Hirokatsu Miyata, Hadano-shi (JP); Kohei Okamoto, Yokohama-shi (JP); Wataru Kubo, Inagi-shi (JP); Takashi Noma, Hadano-shi (JP)

(73) Assignee: CANON KABUSHIKI KAISHA, Tokyo (JP)

(21) Appl. No.: 14/344,950

(22) PCT Filed: Sep. 5, 2012
(86) PCT No.: PCT/JP2012/073243

§ 371 Date: Mar. 14, 2014

(30) Foreign Application Priority Data
Sep. 16, 2011 (JP) 2011-202990

(51) Int. Cl. G21K 1/06

(52) U.S. Cl. CPC G21K 1/06
USPC 378/145

(57) ABSTRACT

An X-ray waveguide system capable of forming X-rays having spatial coherence of a large space region has an X-ray collecting optical element which collects incident X-rays; and an X-ray waveguide containing a core and claddings and wave-guiding a collected X-ray collected by the X-ray collecting optical element, in which the core of the X-ray waveguide is a periodic structure body in which a plurality of basic structures containing substances different in the refractive-index real part are periodically disposed, the total reflection critical angle of the collected X-ray at the interface of the core and the cladding is equal to or larger than the Bragg angle corresponding to the period of the core, and the collection angle of the collected X-ray entering the X-ray waveguide is as large as or larger than the double of the Bragg angle.

### TECHNICAL FIELD

The present invention relates to an X-ray waveguide for wave-guiding X-rays and particularly relates to an X-ray waveguide system utilizing an X-ray wave-guiding phenomenon peculiar to an X-ray waveguide employing a periodic structure body for the core.

### BACKGROUND ART

When treating electromagnetic waves with a short wavelength of several 10 nm or lower, the refractive-index difference between foreign substances to the electromagnetic waves is as small as 10⁻⁴ or lower, and therefore the total reflection critical angle also becomes very small. Therefore, in order to control such electromagnetic waves including X-rays, a large-sized space optical system has been used and is still mainly used. As main parts constituting the space optical system, a multilayer film reflection mirror in which materials different in the refractive index are alternately laminated is mentioned and has various functions, such as beam shaping, spot size conversion, and wavelength selection.

In contrast to the mainly used space optical system, in recent years, an X-ray waveguide in which electromagnetic waves are confined in a core surrounded by claddings, and then propagated has been researched, aiming at a reduction in the size and an increase in the performance of optical systems. Furthermore, a thin film waveguide of a one-dimensional structure in which a core layer is sandwiched between cladding layers (NPL 1) is disclosed. Moreover, an X-ray waveguide of a two-dimensional confinement structure in which a fiber-like core is made to pass through cladding material (NPL 2) is disclosed.

### Citation List

### Non Patent Literature

NPL 1 Salditt, T., Kruger, S. P., Fuhse, C.&Bähtz, C. High-transmission planar x-ray waveguides. Physical Review Letters, 100 (2008)
NPL 2 Jarre, A. et al. Two-Dimensional Hard X-Ray Beam Compression by Combined Focusing and Waveguide Optics, Physical Review Letters, 94 (2005)

### SUMMARY OF INVENTION

### Technical Problem

However, former X-ray waveguides have had problems to be improved.

In both NPL 1 and NPL 2, a 0 order mode whose propagation angle is the smallest among waveguide modes is mainly utilized in order to reduce X-ray wave-guiding loss. In electromagnetic waves in the X-ray wavelength range, the refractive-index difference (real part) between substances is extremely small, and therefore the propagation angle in the 0 order mode becomes small, and, as a result, it has been required to produce a very minute core in the X-ray waveguide. Therefore, the area of X-rays to be propagated becomes small, X-ray beams to be emitted from the X-ray waveguide are small, and the space region of the spatial coherence which is one of the features of the waveguide is limited.

Furthermore, in the case of the X-ray waveguide of the two-dimensional confinement structure as described in NPL 2, it has been very difficult to produce a core having a size of about several 10 nm to be required.

The present invention provides an X-ray waveguide system capable of forming X-rays having spatial coherence of a large space region.

### Solution to Problem

An X-ray waveguide system which solves the above-described problems, includes: an X-ray collecting optical element which collects incident X-rays; and an X-ray waveguide containing a core and claddings and wave-guiding the collected X-ray collected by the X-ray collecting optical element, in which the core of the X-ray waveguide is a periodic structure body in which a plurality of basic structures containing substances different in the refractive-index real part are periodically disposed, the total reflection critical angle of the collected X-ray at the interface of the core and the cladding is equal to or larger than the Bragg angle corresponding to the period of the core, and the collection angle of the collected X-ray entering the X-ray waveguide is as large as or larger than the double of the Bragg angle.

### Advantageous Effects of Invention

The invention can provide an X-ray waveguide system capable of forming X-rays having spatial coherence of a large space region.

### BRIEF DESCRIPTION OF DRAWINGS

FIGS. 1A and 1B are schematic views illustrating one embodiment of an X-ray waveguide system of the invention.

FIG. 2 is a schematic view illustrating one embodiment of an X-ray waveguide for use in the invention.

FIG. 3 is a view illustrating the X-ray electric field intensity distribution in a periodic structure body.

FIGS. 4A and 4B are views illustrating a waveguide mode (periodic resonant waveguide mode) resonating with the periodic structure.

FIG. 5 is a schematic view illustrating a two-dimensional confinement x-ray waveguide.

FIG. 6 is a schematic view illustrating a waveguide mode formed in the two-dimensional confinement x-ray waveguide.

FIGS. 7A and 7B are views illustrating interference patterns of Examples 1 and 2.

### DESCRIPTION OF EMBODIMENTS

The present invention is described in detail below.

The X-ray waveguide system according to the invention includes: an X-ray collecting optical element which collects incident X-rays; and an X-ray waveguide containing a core and claddings and wave-guiding the collected X-ray collected by the X-ray collecting optical element, in which the core of the X-ray waveguide is a periodic structure body in which a plurality of basic structures containing substances different in the refractive-index real part are periodically disposed, the total reflection critical angle of the collected X-ray at the interface of the core and the cladding is equal to or larger than the Bragg angle corresponding to the period of the core, and the collection angle of the collected X-ray entering the X-ray waveguide is as large as or larger than the double of the Bragg angle.

The X-ray waveguide system according to the invention has an X-ray waveguide and an X-ray collecting optical element for producing a collected X-ray entering in the X-ray waveguide. As described later, since the X-ray waveguide for use in the invention contains a periodic structure body for the core, an X-ray beam in which the space region of a portion having spatial coherence is large can be extracted. Furthermore, by adjusting the collection angle of the collected X-ray in such a manner that the collected X-ray can be more efficiently coupled to a waveguide mode resonating with the periodic structure body, outgoing X-rays having higher intensity can be obtained.

The X-ray waveguide for use in the invention produces the periodic structure body serving as the core of the X-ray waveguide by a self-assembly process of amphiphilic organic materials. This allows the production of an advanced periodic structure body by an easy process and the size of the core to be required is larger than before. Therefore, an excellent X-ray waveguide system can be manufactured with simplicity, in a short time, and at a low cost. Moreover, by adjusting the production conditions in this process, the optical characteristics of the X-ray waveguide system can be controlled.

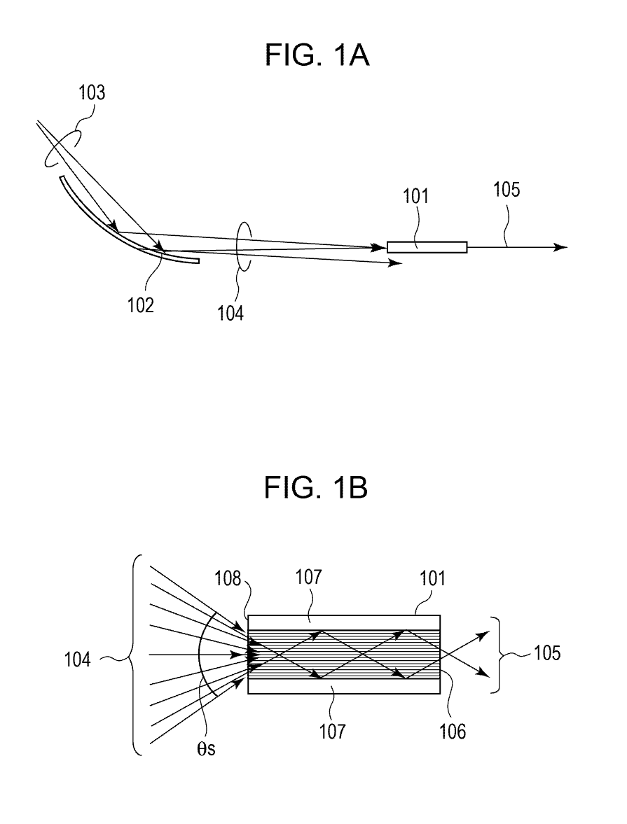

FIGS. 1A and 1B are schematic views illustrating one embodiment of the X-ray waveguide system of the invention, in which FIG. 1A is a general view of the X-ray waveguide system and FIG. 1B is a view illustrating collected X-rays entering the X-ray waveguide and outgoing X-rays to be emitted. In FIGS. 1A and 1B, the X-ray waveguide system according to the invention has an X-ray waveguide 101 and an X-ray collecting optical element 102. The X-ray waveguide 101 contains a core 106 and cladding 107. Incident X-rays 103 are collected by the X-ray collecting optical element 102 to be formed into collected X-rays 104 to be emitted to the X-ray waveguide 101. Reference numeral 108 denotes an end surface portion of the X-ray waveguide. The collected X-rays 104 enter the X-ray waveguide 101 from the end surface portion 108. θs represents the collection angle of the collected X-rays 104.

The collected X-rays 104 contain X-rays having various angle components. When the angles thereof are in agreement with the propagation angle of a waveguide mode which can be present in the X-ray waveguide 101, the X-rays are coupled to the waveguide mode to be made to enter the X-ray waveguide 101. Herein, the waveguide mode refers to an X-ray beam having a peculiar electric field profile formed in the X-ray waveguide. In the X-ray waveguide 101 for use in the invention, the propagation loss of the waveguide mode resonating with the periodic structure of the core (hereinafter referred to as the periodic resonant waveguide mode) is remarkably smaller than that of the other waveguide modes. Therefore, the X-rays in the periodic resonant waveguide mode are selectively penetrated. Due to this high mode selectivity, the X-rays which are selected and penetrated have spatial coherence and outgoing X-rays 105 are selectively emitted from the X-ray waveguide 101.

In the invention, front coupling in which X-rays enter the end portion of the X-ray waveguide 101 is used for the emission of the collected X-rays 104 to the X-ray waveguide 101. As another method, resonance coupling is mentioned in which X-rays having high parallelism are made to enter from the waveguide upper portion. Although the front coupling is inferior to the resonance coupling in the selectivity of waveguide modes, outgoing collected X-rays 104 having higher intensity can be emitted. Moreover, since X-rays can be more efficiently confined by the cladding layer having sufficient thickness, the outgoing X-rays 105 having higher intensity can be emitted. In the X-ray waveguide of the two-dimensional confinement structure, the resonance coupling cannot be used due to the structure. Therefore, it is necessary to make X-rays enter the X-ray waveguide by the front coupling.

In the X-ray waveguide system of the invention, the collection angle of the collected X-rays can be as large as or larger than the double of the Bragg angle in the front coupling. Therefore, X-rays constituting collected X-rays and are coupled to the periodic resonant waveguide mode can more efficiently excite the periodic resonant waveguide mode, and the outgoing X-rays 105 having spatial coherence of a large space region can be extracted with higher intensity.

When X-rays with a wavelength of 0.2 nm or more (6.2 keV or lower) are included in the wavelength range of the incident X-ray 103, the absorption or the like of the X-rays by air become noticeable. Therefore, the entire X-ray waveguide system may be covered with a vacuum chamber to reduce the pressure in the system.

### X-Ray Waveguide

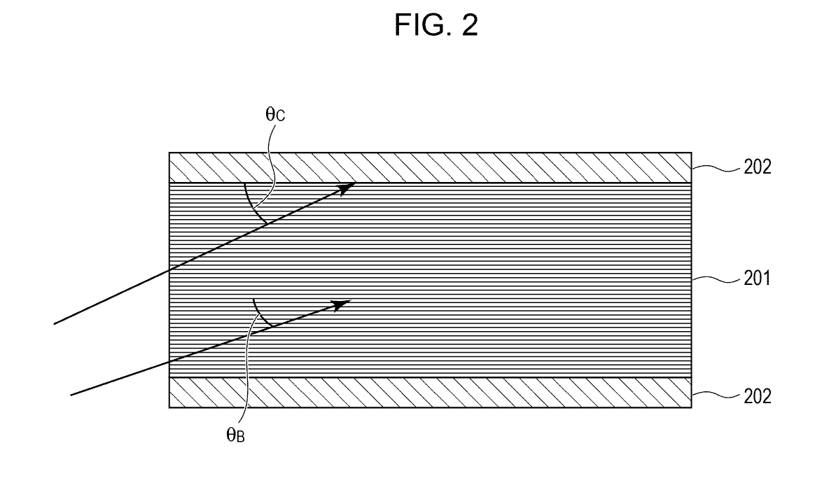

FIG. 2 is a schematic view illustrating one embodiment of the X-ray waveguide for use in the invention. The X-ray waveguide according to the invention is constituted by a core 201 for wave-guiding X-rays in a wavelength region where the refractive-index real part of substances is 1 or lower and claddings 202 for confining the X-rays in the core. The core 201 contains a periodic structure body formed by periodically disposing basic structures containing substances different in the refractive-index real part. The total reflection critical angle θ_{C} of the X-rays at the interface of the cladding and the core is larger than the Bragg angle θ_{B} corresponding to the periodicity of the basic structures of the periodic structure body of the core.

The X-ray waveguide for use in the invention is an X-ray waveguide capable of selectively utilizing a waveguide mode corresponding to the periodicity of the periodic structure body by the use of the periodic structure body for the core 201.

### X-Ray

In the invention, the X-ray is an electromagnetic wave in a wavelength region where the refractive-index real part of substances is 1 or lower. Specifically, the X-ray in the invention refers to an electromagnetic wave with a wavelength of 100 nm or lower including an extreme ultra violet (EUV) light. Since the frequency of the electromagnetic wave of such a short wavelength is very high and the outermost shell electrons of substances cannot respond, the frequency band is different from the frequency band of electromagnetic waves (visible light or infrared rays) having a wavelength equal to or higher than the wavelength of UV light. It is known that the real part of the refractive index of substances to X-rays is smaller than 1. As represented by the following equation (1),

### [Math. 1]

n=1−δ−\tilde{β}=ñ−i\tilde{β} (1)

the refractive index n of substances to such an X-ray is represented using a shift amount δ from 1 of the real part and an imaginary number part β relating to absorption.

### [Math. 2]

\tilde{β} (2)

Except for a case where the energy absorption end peculiar to atoms contributes, since δ is generally proportional to the electron density ρₑ of substances, the refractive-index real part becomes smaller in substances with a higher electron density. The refractive-index real part is represented by the following equation (3).

### [Math. 3]

ñ=1−δ (3)

Furthermore, the electron density ρₑ is proportional to the atomic density ρₐ and the atomic number Z. Thus, although the refractive index of substances to X-rays is represented by a complex number, the real part is referred to as a refractive-index real part or a real part of a refractive index and the imaginary part is referred to as a refractive index imaginary part or an imaginary part of a refractive index in this description.

In this description, a vacuum is also considered as one of the substances. Although a substance in which the refractive-index real part reaches the maximum is a vacuum, the refractive-index real part of air reaches the maximum to almost all the substances that are not in a gaseous state under a general environment. In the invention, two or more kinds of substances different in the refractive-index real part are two or more kinds of substances different in the electron density in many cases.

### Relationship Between Core and Cladding

The X-ray waveguide for use in the invention confines X-rays in the core by the total reflection at the interface of the core and the cladding to wave-guide the X-rays. In order to realize the total reflection, the X-ray waveguide for use in the invention has a refractive-index real part of a core material located at the interface with the cladding larger than the refractive-index real part of cladding material.

In the invention, the total reflection critical angle at the interface of the core and the cladding is represented by θ_{c} as the angle from the interface of the core and the cladding as illustrated in FIG. 2.

### Core

In the X-ray waveguide for use in the invention, a periodic structure body containing substances different in the refractive-index real part is used for the core. Due to the fact that the core has the periodic structure, the waveguide mode formed in the waveguide resonates with the periodic structure. In such a periodic structure having different refractive-index real parts, when the periodicity is infinite, a photonic band is formed between the propagation constant and the angle frequency of X-rays, so that X-rays other than X-rays having a specific mode corresponding to the periodicity cannot be present in this structure.

The periodic structure body is a structure body in which basic structures are periodically arranged. A one-dimensional periodic structure to a three-dimensional periodic structure can be mentioned as an example. Specifically mentioned are a one-dimensional periodic structure in which a laminar structure is the basic structure and the laminar structure is laminated, a two-dimensional periodic structure in which a cylindrical structure is the basic structure and the cylindrical structure is laminated, a three-dimensional periodic structure in which a cage structure is the basic structure and the cage structure is laminated, and the like.

The waveguide mode resonating with the periodic structure formed in the X-ray waveguide for use in the invention originates from multiple reflections corresponding to each dimension of the periodic structure of the periodic structure body. Such a waveguide mode is formed with the resonance with the periodicity and the positions of the antinode and the node of the electric field intensity distribution of X-rays are in agreement with the positions thereof in regions of substances constituting the basic structures. In this case, a region of a substance with a low electron density of the periodic structure body serves as the antinode. More specifically, since the electric field intensity of X-rays concentrate on a substance with small penetration loss, the propagation loss of the waveguide mode becomes remarkably small as compared with other waveguide modes, so that the waveguide mode can be selectively extracted. Hereinafter, the waveguide mode is referred to as a periodic resonant waveguide mode.

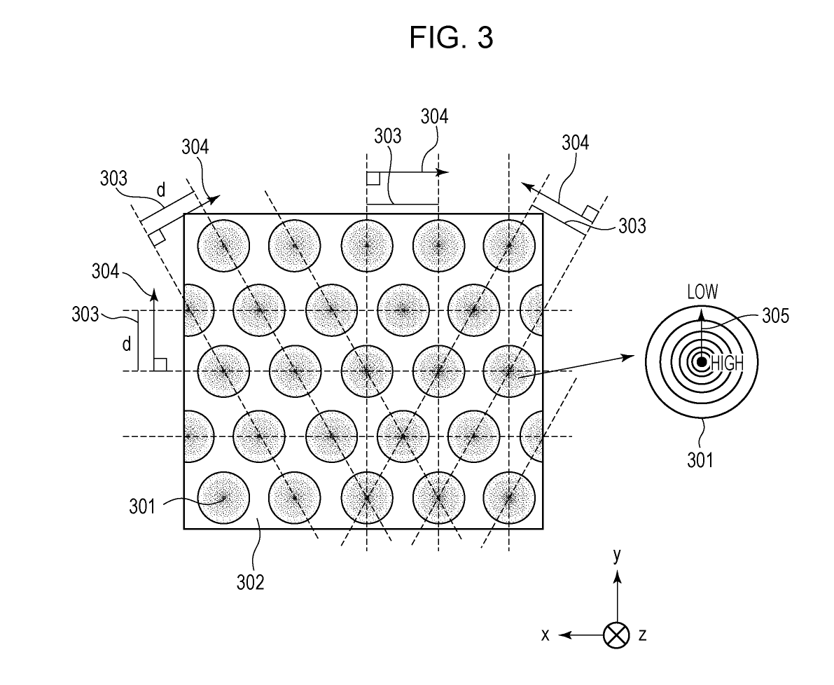

FIG. 3 is an explanatory view illustrating the X-ray electric field intensity distribution in the periodic structure body of the core. FIG. 3 illustrates an example of the electric field intensity distribution of X-rays in the periodic structure body in which cylindrical air holes 301 extending in one direction form a three-dimensional triangular lattice structure in a direction (x-y in-plane direction) perpendicular to the longitudinal direction (z direction in the drawing) in a silica 302. The X-ray propagation direction is a direction perpendicular to the sheet (z direction). A structural periodicity 303(d) is defined as the period (interval between the dashed lines of FIG. 3) of the periodic structures periodically disposed in a direction (x-y plane) perpendicular to the wave-guiding direction (propagation direction, z direction) as illustrated in FIG. 3, and the size varies depending on the periodic structure. The direction of the periodic structures (direction perpendicular to the dashed line on the x-y plane in FIG. 3) is defined as a period direction 304 in this description. In the case of periodic structures of two or more dimensions as illustrated in FIG. 3, a plurality of the structural periodicities 303 and period directions 304 are present. The structural periodicity 303 and the period direction 304 can be measured by X-ray diffraction. Although the number of the structural periodicities 303 and the period directions 304 of FIG. 3 is four, the number thereof is not limited thereto.

In FIG. 3, the structural periodicity d is represented by the dashed line. The monochrome contrast in the cylindrical air holes 301 represents the electric field intensity of X-rays and represents the electric field intensity distribution about one of the waveguide modes formed in this material. The black and white are equivalent to the degrees of the electric field intensity, i.e., high and low, respectively. The electric field intensity is described by the space of a large number of circles in place of the monochrome contrast. The size of the space of the large number of circles in the cylindrical air holes 301 represents the electric field intensity 305 of X-rays and represents an electric field intensity distribution about one of the waveguide modes formed in the material. A small space of the large number of the circles represents that the electric field intensity is high and a large space of the large number of the circles represents that the electric field intensity is low. At the center portion of the air holes 301, the space of the circle is small and the electric field intensity 305 is high. The space of the circle increases while inclining from the center portion in the circumferential direction of the hole, so that the space of the circle is large at the peripheral portion of the hole and the electric field intensity is low. Regions in which the electric field intensity reaches the maximum and the minimum are periodically repeated in the x direction and in the y direction, so that the electric field concentrates on the holes (basic structures 305 of the periodic structure body) of the periodic structure body. The air holes 301 represent the basic structures of the periodic structure body. Reference numeral 304 denotes a period direction.

### Confinement Relationship

In the X-ray waveguide for use in the invention, a waveguide mode in a case where a uniform medium having an average refractive index is used for the entire core is present, in addition to the periodic resonant waveguide mode, which is hereinafter referred to as a uniform waveguide mode.

In contrast to the uniform waveguide mode, the periodic resonant waveguide mode for use in the X-ray waveguide for use in the invention has little loss as compared with an approaching mode, and has higher selective penetration properties as compared with other modes. Therefore, almost penetration X-rays are X-rays derived from the periodic resonant waveguide mode, the phases thereof are spatially uniform, and the X-rays have space coherence. The X-ray waveguide for use in the invention is designed in such a manner that the structural periodicity 303(d) satisfies the following equation (4) in order to form the above-described periodic resonant waveguide mode, in addition to the uniform waveguide mode, by the total reflection at the interface of the cladding and the core.

In particular, when the core is sandwiched between two claddings, the period direction of FIG. 3 is brought into agreement with a direction perpendicular to the wave-guiding direction and a direction perpendicular to the claddings.)

$$\begin{matrix}[ Math . 4 ] & \\ {θ}_{C} > {θ}_{B} \approx \frac{180}{π} arcsin ( \frac{1}{{n}_{avg}} m \frac{λ}{2 d} ) & ( 4 )\end{matrix}$$

θ_{c}(° is the total reflection critical angle at the interface of the cladding and the core. θ_{B}(°) is the Bragg angle by the structural periodicity d in the period direction. λ is the wavelength of X-rays. n_{avg} is the real part of the average refractive index of the core.

Under the conditions, not only the uniform waveguide mode but the periodic resonant waveguide mode is present in the X-ray waveguide for use in the invention. In the periodic resonant waveguide mode in the X-ray waveguide for use in the invention, the periodic structure body is finite. Therefore, the mode formed in the periodic structure body when assuming that the periodic structure body is infinite is a mode which is modulated by the waveguide structure in which X-rays are confined by the total reflection at the interface of the cladding and the core. However, almost similarly as in the case where the periodic structure body is infinite, the antinode portion and the node portion in which the electric field intensity of the electric field intensity distribution in the periodic resonant waveguide mode in a plane perpendicular to the propagation direction is the maximum are in agreement with the basic structures of the periodic structure, respectively. Since the loss in such a periodic resonant waveguide mode becomes remarkably smaller than that of the approaching uniform waveguide mode, wave-guiding of mode-selected X-rays can be achieved.

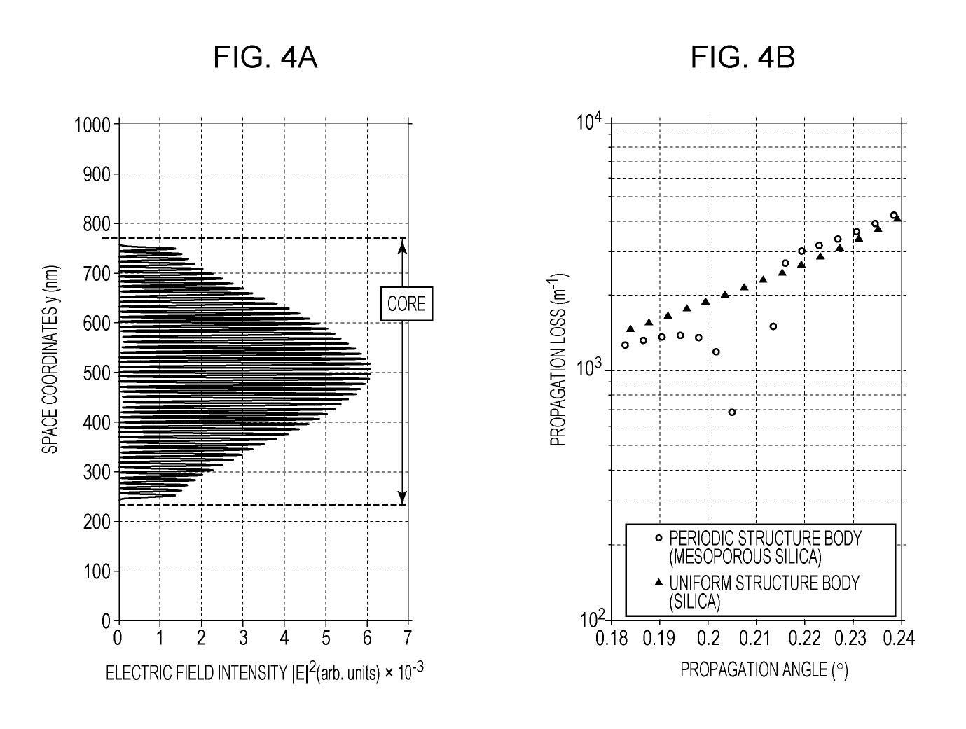

FIGS. 4A and 4B are views illustrating a waveguide mode (periodic resonant waveguide mode) resonating with the periodic structure.

FIG. 4A illustrates the profile of the electric field intensity of the periodic resonant waveguide mode in a waveguide in which mesoporous silica, described later, is used for the core and gold is used for the cladding, in which the maximum portion of the electric field intensity is in agreement with pore portions of mesoporous silica. In the periodic resonant waveguide mode, the electric field intensity concentrates near the core center, and bleeding to the cladding hardly occurs, so that a waveguide mode in which the phase profile is controlled is realized.

FIG. 4B is a view illustrating the propagation angular dependence of the X-ray propagation loss, and shows that the waveguide mode of a propagation angle of about 0.205° corresponds to the periodic resonant waveguide mode, and the propagation loss thereof becomes remarkably small as compared with the propagation loss of other waveguide modes. The propagation angle of the periodic resonant waveguide mode is slightly smaller than the Bragg angle of the periodic structure body. These results are obtained by theoretically calculating the waveguide modes which can be present in the waveguide by a finite element method.

As illustrated in FIG. 4B, in the X-ray waveguide in which the core is constituted by a uniform silica, the periodic resonant waveguide mode is not present and the propagation loss merely monotonously increases with an increase in the propagation angle. In contrast, by the use of the periodic structure body for the core, a periodic resonant waveguide mode in which the propagation loss is remarkably small can be selectively extracted. Furthermore, the X-ray waveguide for use in the invention has an advantage in that, as an increase in the periodicity of the periodic structure body of the core, a resonance effect with the periodic structure becomes noticeable and the propagation loss decreases. This is because the contribution of the multiple reflections by the periodic structure body becomes higher. It is desirable that the periodicity of the periodic structure of the core of the X-ray waveguide for use in the invention is 10 or more, suitably 50 or more, depending on the target X-ray wavelength range or the size of the structural periodicity 303.

The increase in the periodicity of the periodic structure is equivalent to increasing the cross-sectional area of the core of the X-ray waveguide 101. Therefore, the X-ray waveguide 101 for use in the invention has the most distinctive feature in that the cross-sectional area of the core is larger than before and X-ray beams having spatial coherence of a large space region can be generated.

### Cladding Material

The refractive-index real part of the cladding at the interface of the cladding and the core is referred to as n_{clad} and the refractive-index real part of the core at the interface is referred to as n_{core}. The total reflection critical angle θ_{c)}(° from a direction parallel to the film surface in this case is represented by the following equation (5) under the relationship of n_{clad}<n_{core}.

$$\begin{matrix}[ Math . 5 ] & \\ {θ}_{C} = \frac{180}{π} arccos ( \frac{{n}_{clad}}{{n}_{core}} ) & ( 5 )\end{matrix}$$

The cladding material of the X-ray waveguide for use in the invention can be constituted by a material in which other structural parameters and the physical property parameters of the waveguide satisfy equation (5). For example, when mesoporous silica which is a two-dimensional periodic structure in which pores are arranged in the shape of a triangular lattice with a period of 10 nm in a confined direction is used for the core, the cladding can be constituted by Au, W, Ta, or the like.

However, it is suitable to use a material with a low absorptivity of X-rays of a target wavelength range (energy range) of the X-ray waveguide system of the invention for the material of the cladding. In particular, it is suitable to use a material having no absorption end of X-rays in the target wavelength range of X-rays for the cladding.

### Material of Periodic Structure Body

For materials of the periodic structure body for use in the core of the X-ray waveguide for use in the invention, a periodic structure body or the like which is produced by a former top-down process or a self-assembly process can be used without being particularly limited. For example, a multilayer film formed by sputtering or a vapor deposition method, a periodic structure body formed by photolithography, electron beam lithography, an etching process, lamination, pasting, or the like, can be used. In particular, by the use of oxides for substances constituting the periodic structure body, oxidation degradation can be prevented.

As the core of the X-ray waveguide for use in the invention, it is suitable that the core is a mesostructure film containing an organic substance and an inorganic substance particularly in terms of simpleness of a manufacturing process thereof or a periodic structure body with high regularity and, moreover, it is suitable that the core is mesoporous film from the viewpoint of the penetration of X-rays. This is described below.

The mesostructure film in the invention is a composite material film in which an organic component and an inorganic component are alternately disposed at a scale of a nanometer order. The organic component is one in which amphiphilic substances typified by surfactants has self-assembled. By utilizing the self-assembly of amphiphilic substances, the mesostructure film having high structural regularity can be formed. The structure includes a one-dimensional periodic structure in which a laminar structure is the basic structure and the laminar structure is laminated, a two-dimensional periodic structure in which a cylindrical structure is the basic structure and the cylindrical structure is laminated, and a three-dimensional periodic structure in which a cage structure is the basic structure and the cage structure is laminated. The mesoporous film is one in which the organic component is removed from the mesostructure film and is a film of a porous material in which pores are arranged with a high order. However, in the invention, the organic component may remain in the pores of the mesoporous film insofar as the mesoporous film has a required performance.

The “meso” of the mesoporous film refers to the fact that the size is 2 to 50 nm according to IUPAC (International Union of Pure and Applied Chemistry). Therefore, the mesoporous film is defined as a porous film in which the pore diameter of fine pores thereof is 2 to 50 nm. In the mesostructure film and the mesoporous film, a periodic structure is formed in a self-assembly manner by giving a reaction liquid mainly containing a precursor of oxides and amphiphilic substances typified by surfactants by a process, such as coating, onto a substrate. In a process employing amphiphilic molecules, a periodic structure due to the self-assembly thereof is formed, and therefore a periodic structure body with high regularity can be formed. Therefore, the periodic structure body can be produced with extreme ease and with a high throughput without requiring a large number of processes, such as a former top-down process. The formation of a periodic structure body of tens of nanometers is very difficult to achieve by a former top-down process, and in particular, it can be said that it is almost impossible to produce two or more dimensional periodic structure bodies.

The mesostructure film for use in the invention forms a periodic structure with inorganic components and organic components. For the inorganic components, inorganic oxides are suitably used, and silica, titanium oxide, zirconium dioxide, and the like can be mentioned. As the organic components, amphiphilic molecules typified by surfactants or block polymers, alkyl chain portions of siloxane oligomers, alkyl chain portions of silane coupling agents, or the like can be mentioned, for example. As the surfactants, C₁₂H₂₅(OCH₂CH₂)₄OH, C₁₆H₃₅(OCH₂CH₂)₁₀OH, C₁₈H₃₇(OCH₂CH₂)₁₀OH, Tween 60 (Tokyo Kasei Kogyo), Pluronic L121 (BASF A.G.), Pluronic P123 (BASF A.G.), Pluronic P65 (BASF A.G.), Pluronic P85 (BASF A.G.), and the like can be mentioned. By appropriately selecting the type, the molecular weight, the molecular weight ratio of a hydrophilic portion and a hydrophobic portion, and the like of the inorganic components and the organic components, the dimension or the structural periodicity (plane interval obtained from the Bragg diffraction) of the periodic structure of the periodic structure body can be adjusted. Table 1 shows the structure of the periodic structure body to the organic substance (amphiphilic molecules) to be used.

TABLE 1

| | Dimension of | Structural |
|---|---|---|
| Organic substance | periodic structure | periodicity (nm) |
| Pluronic L121 | One dimension | 11.6 |
| Pluronic P123 | Two dimensions | 10.4 |
| Pluronic P85 | Two dimensions | 9.3 |

The mesostructure film for use in the invention is formed by giving a reaction liquid containing the organic component and the precursor of the inorganic component thereof to a substrate or the like and using a self-assembly process. As a method for giving the reaction liquid, known methods can be used. Methods for applying the reaction liquid to a substrate by spin coating or dip coating, a hydrothermal synthesis method including bringing the reaction liquid into contact with a substrate and holding the same, and then heating the same, and the like can be mentioned. In this case, by the use of known methods, e.g., subjecting a substrate to an anisotropic process by, for example, forming a polyimide film which is subjected to rubbing treatment on a substrate, applying a shearing stress to a substrate when giving the reaction liquid, or the like, a mesostructure film can be formed in which the orientation direction is uniform in one direction in the plane of the substrate. By bringing the orientation direction into agreement with the X-ray wave-guiding direction, the X-ray waveguide with a smaller propagation loss can be provided.

In order to produce the mesoporous film from the mesostructure film, the organic component can be removed by known methods, such as firing, extraction by an organic solvent, or ozone oxidation treatment.

For the material of the periodic structure body which is the core, it is suitable to use a material with a low absorptivity of X-rays of a target wavelength range (energy range) of the X-ray waveguide system of the invention. In particular, it is suitable to use a material having no absorption end of X-rays in the target wavelength range of X-rays for the core. The core is suitably a multilayer film. Moreover, the core is suitably mesoporous film. The core is suitably produced by the self-assembly process using a reaction liquid containing an amphiphilic organic material.

### Confinement Dimension

The dimension of confining X-rays of the X-ray waveguide for use in the invention may be one-dimensional in which a film-like core is sandwiched between claddings or may be two-dimensional in which a core whose cross-section perpendicular to the wave-guiding direction has a circular or rectangular shape is surrounded by claddings. In a two-dimensional confinement waveguide, X-rays are two dimensionally confined in the waveguide. Therefore, X-ray beams in which diverging properties are suppressed and the phase is two-dimensionally controlled as compared with those of a one-dimensional confinement waveguide can be extracted. Furthermore, when the periodic structure body is a two-dimensional structure (basic structure: cylindrical structure) or a three-dimensional structure (basic structure: cage structure), the electric field intensity distribution originating from a plurality of periodic structures in a plurality of period directions can be more efficiently formed in the core. More specifically, a two-dimensional periodic resonant waveguide mode can be selectively extracted on the waveguide cross-section, and the outgoing X-rays 105 which have high intensity and are two dimensionally coherent to each other can be provided.

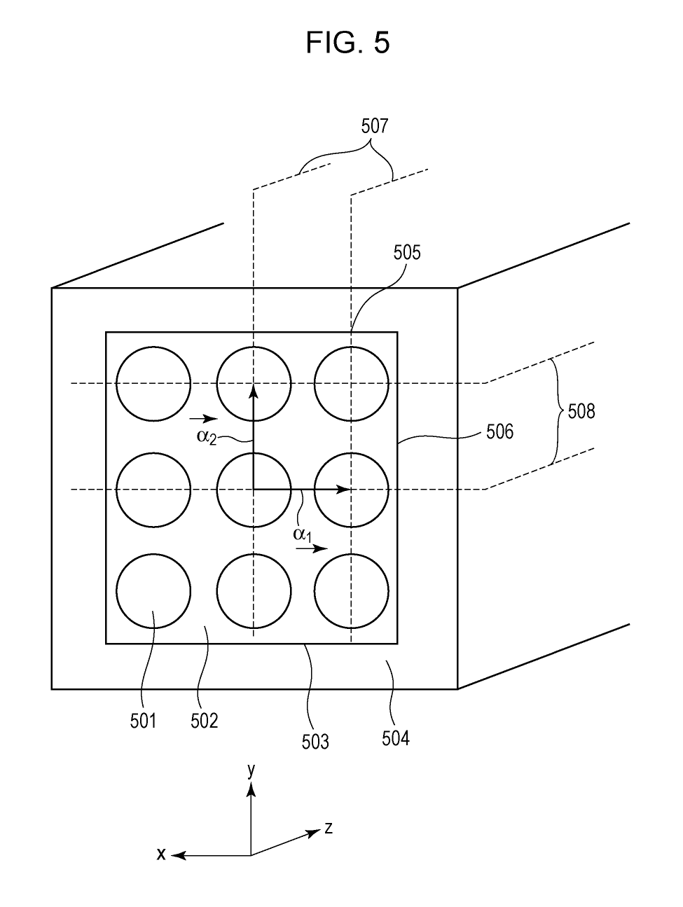

An X-ray waveguide of a two-dimensional confinement structure for obtaining a two-dimensional periodic resonant waveguide mode is described in detail below. The two-dimensional structure of the periodic structure body in this case is a structure in which the periodicity can be expressed by two basic vectors in a plane perpendicular to the wave-guiding direction. For example, as illustrated in FIG. 5, a configuration is mentioned in which a core in which a region 501 of a substance having a large refractive-index real part and a region 502 of a substance having a small refractive-index real part extending in the z direction form a periodic structure in a two-dimensional direction in the x-y plane is surrounded by claddings 504. When the X-ray wave-guiding direction is the z direction, the core has a two-dimensional periodic structure of a square lattice arrangement in the x-y plane perpendicular to the wave-guiding direction, and the periodicity of the periodic structure is expressed by two basic vectors α₁ and α₂ illustrated in the drawing. The periodicity of the periodic structure of FIG. 5 is low in both the x and y directions, which simplifies the description. The two-dimensional periodic structure has a structure in which a plane of one structure which serves as one base is repeated at a period |α₁| in a direction parallel to α₁ and a plane of a structure which serves as the other base is repeated at a period |α₂| in a direction parallel to α₂. The basic vectors α₁ and α₂ can be arbitrarily selected insofar as the periodicity can be expressed. More specifically, another basic vector can be selected by changing the selection manner or using linear combination of the basic vectors even in the same periodic structure. A plane of the structure which serves as the base corresponding to the selected basic vector can be defined. One in which the absolute value of the basic vector is the minimum expresses the most basic periodicity. The periodicity effect becomes higher in a direction parallel to such a basic vector. It is effective to define these directions as specific directions for the formation of a periodic resonant waveguide mode. When α₁ and α₂ are selected as the basic vectors in the example of FIG. 5, the planes of the structures which serve as the base are planes 507 and 508 to α₁ and α₂, respectively, and are periodically repeated in the x direction and the y direction.

Also when the core contains a two-dimensional periodic structure, in the X-ray waveguide for use in the invention, the core and the cladding are constituted in such a manner that the Bragg angle corresponding to the periodicity of the periodic structure in at least one specific direction perpendicular to the X-ray wave-guiding direction is smaller than the total reflection critical angle on at least one interface of the core and the cladding. In the case of the example illustrated in FIG. 5, when one specific direction is defined as the y direction in the x-y plane perpendicular the wave-guiding direction, the cladding and the core are constituted in such a manner that equation (4) above is satisfied between the total reflection critical angle θ_{c} of X-rays at the interface 505 of the core and the cladding in the y-z plane and the Bragg angle θ_{B} obtained by the periodicity in the y direction.

When the core is a two-dimensional periodic structure, the basic periodicity is obtained in two specific directions represented by the two basic vectors. Therefore, two Bragg angles corresponding to the periodicity in the directions can be defined. For example, in the case of the X-ray waveguide of the configuration of FIG. 5, the two specific directions are defined as the x direction and the y direction parallel to the basic vectors α₁ and α₂. The Bragg angles θ_{B1} and θ_{B2} corresponding to the periodicity of the periodic structure in the two specific directions parallel to the basic vectors α₁ and α₂ are represented by the following equations (6) and (7), respectively.

$$\begin{matrix}[ Math . 6 ] & \\ {θ}_{B 1} \approx \frac{180}{π} arcsin ( \frac{1}{{n}_{1 avg}} m \frac{λ}{2 \vert {a}_{1} \vert} ) & ( 6 ) \\ [ Math . 7 ] & \\ {θ}_{B 2} \approx \frac{180}{π} arcsin ( \frac{1}{{n}_{2 avg}} m \frac{λ}{2 \vert {a}_{2} \vert} ) & ( 7 )\end{matrix}$$

n_{1avg} and n_{2avg} are the average refractive indices in the two specific directions parallel to the basic vectors α₁ and α₂ in the core, respectively. The total reflection critical angles at the interfaces 506 and 505 of the core and the cladding in the two specific directions parallel to the basic vectors α₁ and α₂ are defined as θ_{1C} and θ_{2C}, respectively. In order to form periodic resonant waveguide modes in the directions, materials and structural parameters are determined in such a manner as to establish θ_{1B}<θ_{1C} and θ_{2B}<θ_{2C} in the directions similarly as in equation (4). When configured in such a manner that θ_{1B}<θ_{1C} and θ_{2B}<θ_{2C} are satisfied and the total reflection critical angles at the interface of substances in the core in the directions are smaller than the Bragg angles thereof, periodic resonant waveguide modes can be formed in the two specific directions. The periodic resonant waveguide modes obtained in such a waveguide are two-dimensional periodic resonant waveguide modes in which the periodic resonant waveguide modes in two specific directions parallel to the two basic vectors interfere with each other.

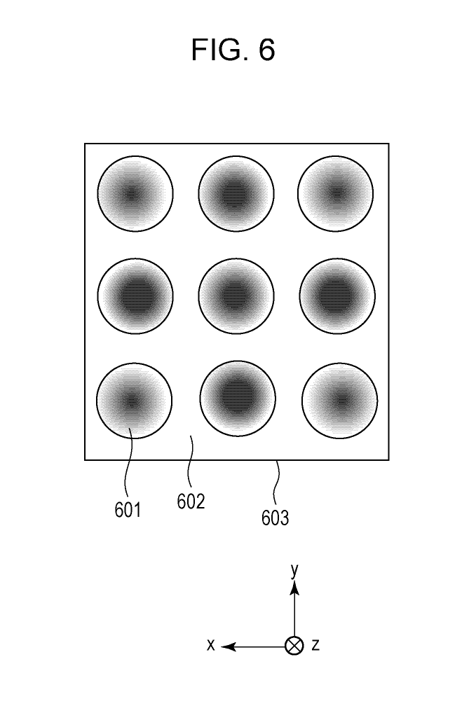

FIG. 6 is a view illustrating the electric field intensity distribution of the periodic resonant waveguide mode in the core on a plane perpendicular to the z direction of the X-ray waveguide of FIG. 5. Reference numeral 601 denotes a region in which the refractive-index real part is large. Reference numeral 602 denotes a region in which the refractive-index real part is small. Reference numeral 603 denotes the interface of the cladding and the core. In FIG. 6, a darker portion (diagonally shaded portion) at the center portion of 601 and a brighter portion represent a portion with higher electric field intensity and a portion with lower electric field intensity, respectively. More specifically, the electric field intensity distribution of the two-dimensional periodic resonant waveguide mode formed in the X-ray waveguide in which the two-dimensional periodic structure is the core is two-dimensional distribution and an electric field concentrates on a region (the region 601 in which the refractive-index real part is large) where loss, such as absorption, is smaller, which shows that the propagation loss of the periodic resonant waveguide mode is small. Also in the two-dimensional periodic resonant waveguide mode, the loss can be made smaller than that of other waveguide modes depending on a design similarly as in the one-dimensional periodic resonant waveguide mode, and a single waveguide mode controlled in the two-dimensional direction can be formed. The electric field or magnetic field distribution of the two-dimensional periodic resonant waveguide mode is regularly controlled in a two-dimensional plane perpendicular to the wave-guiding direction, and the phases of the electric fields or the magnetic fields become regular in the entire core.

The principal lattice defining the periodicity of the two-dimensional periodic structure forming the core is not limited to the square lattice. In the example in which the periodic structure body is a square lattice as illustrated in FIG. 5, two specific directions parallel to the two basic vectors are defined as specific directions. However, the direction is not limited to such a direction, and a direction parallel to a vector using linear combination of the basic vectors can also be used as a specific direction. The number of the specific directions in the two-dimensional plane is not limited to two, and there is a case where the number of the specific directions is 3 or more depending on the periodicity of the periodic structure. For example, in the case of a triangular lattice like two-dimensional periodic structure, by considering a specific direction parallel to a third vector denoted by α₁-α₂ in addition to the two specific directions parallel to the basic vectors α₁ and α₂, X-rays having perpendicular components of three directions interfere with each other to form a two-dimensional periodic resonant waveguide mode. The electromagnetic field intensity distribution of the periodic resonant waveguide mode in this case has a triangular lattice shape, and a distribution is obtained in which an electromagnetic field concentrates on a portion with smaller absorption loss.

The periodic structure forming the core is not limited to the two-dimensional periodic structure, and an X-ray waveguide can be formed also using a three-dimensional periodic structure body as the periodic structure. The forming manner of the periodic resonant waveguide mode in the plane perpendicular to the wave-guiding direction is the same as those of the one-dimensional structure and the two-dimensional structure. In the case of the three-dimensional periodic structure, due to the fact that there is periodicity also in the wave-guiding direction, a wave-guiding X-ray resonates with the periodic structure, so that an effect is obtained that the phases of X-rays are easily made uniform in the wave-guiding direction.

### Incident X-Rays, Collected X-Rays

As the incident X-rays 103, radiation X-rays, X-rays generated when electrons collide to a metal target, fluorescent X-rays from materials, and the like can be used in the X-ray waveguide system of the invention. The incident X-rays 103 are collected by the X-ray collecting optical element 102 to be formed into the collected X-rays 104, and the collected X-rays 104 are made to enter from the end surface portion 108 of the X-ray waveguide 101. When the collected X-rays 104 are made to enter from the end surface portion 108, the X-rays are coupled to a plurality of waveguide modes different in the propagation angle. Then, X-ray beams derived from a periodic resonant waveguide mode with small wave-guiding loss among the X-rays are selectively emitted as the outgoing X-rays 105. When the incident X-rays 103 enter the end surface portion 108, the angle may be changed for entering as appropriate if necessary.

The collected X-rays 104 are made to enter the X-ray waveguide 101 from the end surface portion 108 at a collection angle which is as large as or larger than the double of the Bragg angle corresponding to the periodic structure of the periodic structure body at the X-ray wavelength. In this case, since the X-rays from two directions having an incident angle equivalent to the propagation angle of the periodic resonant waveguide mode are contained in the collected X-rays 104, the collected X-rays 104 can be sufficiently coupled to the periodic resonant waveguide mode. Therefore, multi-wavelength X-rays 105 having higher intensity can be extracted. In this description, the collection angle is defined as a half width in the intensity profile to the collection angle of the collected X-rays.

In contrast, the collection angle is suitably smaller than a small value of the angle 4 times as large as the Bragg angle and the total reflection critical angle of the collected X-ray at the interface of the core and the cladding of the X-ray waveguide 101, in addition to the conditions. By setting an upper limit to the collection angle, an increase in the size of the X-ray condensing optical element 102 can be suppressed. When the collection angle is smaller than the angle 4 times as large as the Bragg angle, an X-ray electric field profile by a waveguide mode resonating with a high order structure of the periodic structure with which the target periodic resonant waveguide mode of the X-ray waveguide system of the invention resonates is not formed in the X-ray waveguide 101. The waveguide mode resonating with the high order structure also has relatively small propagation loss. Therefore, when the collection angle is larger than the angle 4 times as large as the Bragg angle, the selective penetration properties of X-rays by the target periodic resonant waveguide mode of the X-ray waveguide system of the invention are limited. Furthermore, even when X-rays having an incident angle equal to or larger than the total reflection critical angle of the interface of the core and the cladding of the X-ray waveguide 101 are made to enter the X-ray waveguide 101, the X-rays are not coupled to the waveguide mode to leak out from the X-ray waveguide 101. Therefore, the collection angle of the collected X-ray 104 may not be equal to or larger than the total reflection critical angle.

### X-Ray Collecting Optical Element

For the X-ray collecting optical element 102 for use in the X-ray waveguide system of the invention, a known X-ray collecting optical element for X-rays can be used insofar as the requirements of the collection angle described above are satisfied. For example, a Fresnel zone plate, a total reflection mirror (a Kirkpatrick-Baez mirror, KB mirror), a multilayer film mirror, a crystal mirror, a polycapillary, a monocapillary, and the like can be mentioned. In particular, the total reflection mirror, the polycapillary, and the monocapillary are X-ray collecting optical elements utilizing the total reflection of X-rays and the collecting efficiency thereof is relatively excellent, and therefore the total reflection mirror, the polycapillary, and the monocapillary are suitable as the X-ray collecting optical element for use in the invention. Capillary elements, such as the polycapillary and the monocapillary, can constitute a relatively small optical system. Therefore, the capillary elements are more suitable as the X-ray collecting optical element for use in the invention.

### EXAMPLES

Hereinafter, the invention is specifically described with reference to Examples but is not limited thereto.

### Example 1

This example evaluates the waveguide characteristics of an X-ray waveguide system employing an X-ray waveguide constituted by claddings containing tungsten and a core formed of a multilayer film containing B₄C and Al₂O₃ and a polycapillary, a monocapillary, and a Fresnel zone plate for an X-ray collecting optical element.

As a method for producing the X-ray waveguide element of this example, the following processes employing a sputtering method or the like are mentioned.

### (a) Formation of Cladding Layer

Tungsten is formed with a thickness of 30 nm on a Si substrate by magnetron sputtering.

### (b) Formation of Multilayer Film

Al₂O₃ and B₄C are alternately formed into films in this order to form a multilayer film by magnetron sputtering. The thickness of Al₂O₃ and the thickness of B₄C are 4.0 nm and 16.0 nm, respectively. For the layers of the lowermost portion and the uppermost portion of the multilayer film, Al₂O₃ is used. Al₂O₃ and B₄C form 101 layers and 100 layers, respectively.

### (c) Formation of Cladding Layer

Tungsten is formed with a thickness of 30 nm by magnetron sputtering.

### (d) Determination of Waveguide Length

The X-ray waveguide is cut using a dicing device in such a manner that the waveguide length is 4 mm.

In the X-ray waveguide to be obtained, the core is sandwiched between the claddings and X-rays are confined in the core by total reflection at the interface of the core and the cladding. According to this configuration, the relationship of the period of the multilayer film which is the core and the refractive-index real part of substances forming the layers satisfies equation (4) above. For example, with respect to an X-ray of 10 keV, the X-ray is confined in the core by the total reflection at the interface of the core and the cladding, and then the confined X-ray can form a waveguide mode which is affected by the periodicity of the multilayer film. The total reflection critical angle at the interface of the core and the cladding is 0.390°. The Bragg angle corresponding to the periodicity of the basic structure of the periodic structure body of the core is 0.178°.

A collected X-ray (Energy: 10 keV) collected by the polycapillary used as the X-ray collecting optical element is made to enter from the end portion of the X-ray waveguide. Then, the interference pattern formed behind the waveguide (Camera length: 1500 mm) formed by outgoing radiation X-rays 105 to be emitted from the termination portion of the waveguide is measured by an X-ray two-dimensional detector.

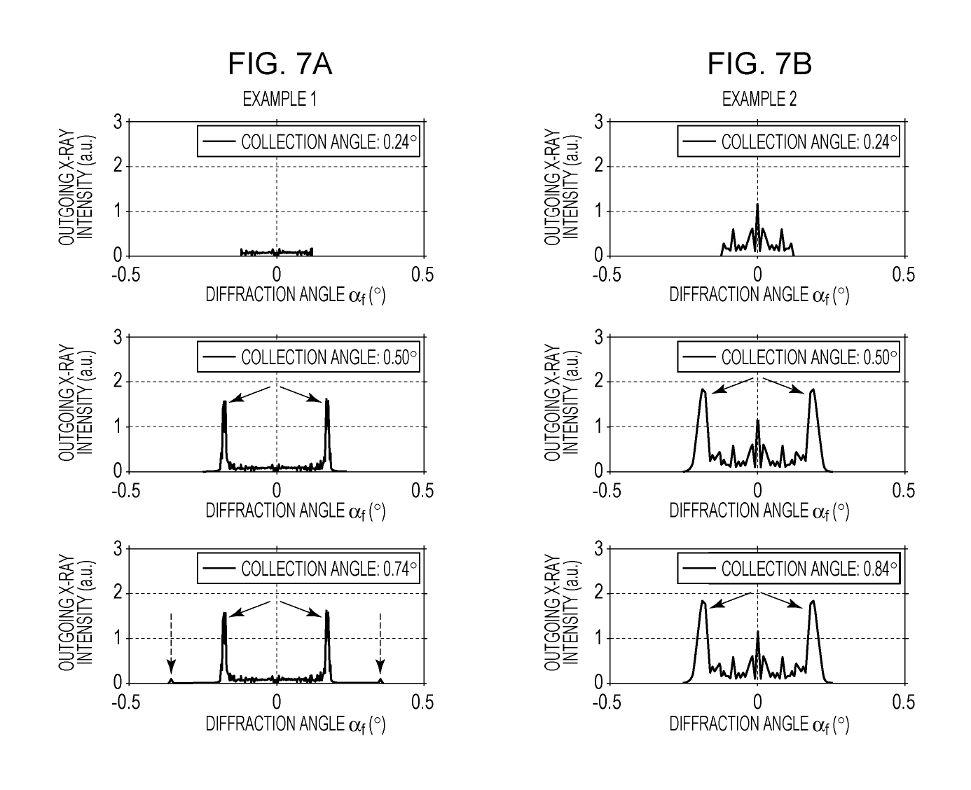

FIG. 7A illustrates, as an example, the interference patterns measured when polycapillaries different in the collection angle performance are used and the collection angles of the collected X-rays are 0.24°, 0.50°, and 0.74°. The interference pattern is a distribution of the outgoing X-ray intensity detected at an angle (Diffraction angle α_{f}) from the termination surface of the waveguide. It is found that when the collection angle is larger than the Bragg angle corresponding to the periodicity of the basic structures of the periodic structure body (Collection angle: 0.50°) is larger than 0.18°, the intensity peak (solid line arrow) of the interference pattern of the outgoing X-rays derived from the periodic resonant waveguide mode is clearly detected. It can be confirmed that the X-rays are selectively penetrated at small propagation loss as compared with X-rays of other waveguide modes. In contrast, when the collection angle is 4 times as large as or larger than the Bragg angle (Collection angle: 0.74°), the interference peak (dotted line arrow) of the X-rays derived from the waveguide mode resonating with the high order structure of the basic structures of the periodic structure body also becomes relatively remarkable. Therefore, the selective penetration of the target periodic resonant waveguide mode is relatively limited.

Even when the X-ray collecting optical element is changed to a monocapillary and a Fresnel zone plate capable of achieving the equivalent X-ray collection angle as the X-ray collecting optical element, the same results as those of FIG. 7A are obtained.

### Example 2

This example evaluates the optical characteristics, such as waveguide characteristics, of an X-ray waveguide system employing an X-ray waveguide constituted by claddings containing tungsten and a core formed with mesoporous silica film and a total reflection mirror, a multilayer film mirror, and a crystal mirror as the X-ray collecting optical element.

In this mesoporous material, air holes form a three-dimensional periodic structure in a direction perpendicular to the X-ray wave-guiding direction (xy in-plane direction). The mesoporous material is mesoporous silica in which a material except the air holes contains silica. A method for producing the X-ray waveguide containing the mesoporous silica of this example is described below.

### (a) Formation of Cladding Layer

Tungsten is formed with a thickness of 20 nm on a Si substrate by magnetron sputtering.

### (b) Preparation of Precursor Solution of Mesostructure Film

The mesoporous silica film is prepared by a spin coating method. A precursor solution of a mesostructure is prepared by stirring and dispersing a block polymer with tetrahydrofuran, adding ethanol, water, 0.1 M hydrochloric acid, and tetraethoxysilane in this order, and then stirring the mixture for 1 hour. For the block polymer, Poly(isobutylene-b-ethylene oxide) is used. The mixing ratio (molar ratio) is set as follows: block polymer: 0.0025, tetrahydrofuran: 9, ethanol: 10, water: 4, hydrochloric acid: 0.006, and tetraethoxysilane: 1.2.

### (c) Film Formation of Mesostructure Film

The precursor solution is spin coated to the substrate which is subjected to sputtering of tungsten at the number of revolutions of 1000 rpm using a spin coating device. The temperature in this case is 25° C. and the relative humidity in this case is 5% or lower. After the film formation, the film is held in a thermohygrostat of a temperature of 25° C. and a relative humidity of 40% for 18 hours or more. Thereafter, the block polymer is removed by solvent extraction using ethanol, tetrahydrofuran, or water or a firing process.

### (d) Evaluation of Mesoporous Silica Film

The prepared mesostructure film is subjected to Bragg-Brentano geometry θ-2θ scanning X-ray diffraction. As a result, it is confirmed that the mesostructure film has order in the normal line direction of the substrate surface and the plane interval, i.e., the structural periodicity in the confinement direction, is 17.8 nm. The film thickness is about 470 nm.

### (e) Formation of Cladding Layer

Tungsten is formed with a thickness of 20 nm by magnetron sputtering.

### (f) Determination of Waveguide Length

The X-ray waveguide is cut using a dicing device in such a manner that the waveguide length is 4 mm.

The obtained X-ray waveguide satisfies equation (4) above because the period is 17.8 nm. For example, with respect to an X-ray of 10 keV, the X-ray is confined in the core by the total reflection at the interface of the core and the cladding, and then the confined X-ray can form a waveguide mode which is affected by the periodicity of the mesoporous silica (periodic resonant waveguide mode). The total reflection critical angle at the interface of the core and the cladding is 0.397°. The Bragg angle corresponding to the periodicity of the basic structures of the periodic structure body of the core is 0.20°.

A collected X-ray (Energy: 10 keV) collected by the total reflection mirror used as the X-ray collecting optical element are made to enter from the end portion of the X-ray waveguide. Then, the interference pattern formed behind the waveguide (Camera length: 1500 mm) formed by outgoing radiation X-rays 105 to be emitted from the termination portion of the waveguide is measured by an X-ray two-dimensional detector.

FIG. 7B illustrates, as an example, the interference patterns measured when total reflection mirrors different in the collection angle performance are used and the collection angles of the collected X-rays are 0.24°, 0.50°, and 0.84°. The interference pattern is a distribution of the outgoing X-ray intensity detected at an angle (Diffraction angle α_{f}) from the termination surface of the waveguide. It is found that when the collection angle is larger than the Bragg angle corresponding to the periodicity of the basic structures of the periodic structure body (Collection angle: 0.50°) is larger than 0.20°, the intensity peak (solid line arrow) of the interference pattern of the outgoing X-rays derived from the periodic resonant waveguide mode is clearly detected. It can be confirmed that the X-rays are selectively penetrated at small propagation loss as compared with X-rays of other waveguide modes. However, when the collection angle)(0.84° is equal to or larger than the total reflection critical angle of the core and the cladding, it is found that the interference pattern is the same as that obtained when the collection angle is 0.50°. This is because the X-rays of angle components equal to or larger than the total reflection critical angle do not contribute to the X-ray waveguide. By setting the collection angle of the collected X-ray to be equal to or smaller than the total reflection critical angle, an increase in the size of the X-ray collecting optical element can be suppressed.

Even when the X-ray collecting optical element is changed to a multilayer film mirror and a crystal mirror which can achieve the equivalent X-ray collection angle as the X-ray collecting optical element, the same results as those of FIG. 7B are obtained.

The comparison between the optical characteristics of the X-ray waveguide system of Example 1 (FIG. 7A) and the optical characteristics of the X-ray waveguide system of Example 2 (FIG. 7B) shows that the outgoing X-rays 105 having higher intensity can be extracted in the X-ray waveguide system of Example 2. This is because the periodic structure body which is the core is mesoporous silica having low X-ray absorptivity, and particularly the X-ray absorptivity of air holes thereof is low.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-202990, filed Sep. 16, 2011, which is hereby incorporated by reference herein in its entirety.

### INDUSTRIAL APPLICABILITY

Since the X-ray waveguide system of the invention can form X-rays having spatial coherence of a large space region, the invention can be applied to imaging and analysis using X-rays.

### REFERENCE SIGNS LIST

101 X-ray waveguide
102 X-ray collecting optical element
103 incident X-ray
104 collected X-ray
105 outgoing X-ray
106 core
107 cladding
108 end surface portion of X-ray waveguide

1. An X-ray waveguide system, comprising:
an X-ray collecting optical element which collects incident X-rays; and
an X-ray waveguide having claddings and a core which is a periodic structure body in which a plurality of basic structures containing substances different in a refractive-index real part are periodically disposed and wave-guiding a collected X-ray collected by the X-ray collecting optical element,
a total reflection critical angle of the collected X-ray at the interface of the core and the cladding being equal to or larger than Bragg angle corresponding to a period of the core, and
the collection angle of the collected X-ray entering the X-ray waveguide being as large as or larger than the double of the Bragg angle.

2. The X-ray waveguide system according to claim 1, wherein the collection angle of the collected X-ray is smaller than an angle 4 times as large as the Bragg angle and also smaller than the total reflection critical angle of the collected X-ray at the interface of the core and the cladding.

3. The X-ray waveguide system according to claim 1, wherein the X-ray collecting optical element is a capillary element, a total reflection mirror, a multilayer film mirror, a Fresnel zone plate, or a crystal mirror.

4. The X-ray waveguide system according to claim 1, wherein the core is a multilayer film.

5. The X-ray waveguide system according to claim 1, wherein the core is mesoporous film.

6. The X-ray waveguide system according to claim 1, wherein the core is produced by a self-assembly process using a reaction liquid containing an amphiphilic organic material.
